(19) United States
(12) Patent Application Publication
(10) Pub. No.: US 2014/0304947 A1
(43) Pub. Date: Oct. 16, 2014

(54) HINGE MODULE AND ELECTRONIC DEVICE

(71) Applicant: Acer Incorporated, New Taipei City (TW)

(72) Inventor: Chuan-Hua Wang, New Taipei City (TW)

(21) Appl. No.: 13/940,244

(22) Filed: Jul. 11, 2013

(30) Foreign Application Priority Data
Apr. 15, 2013 (TW) 102113306

(51) Int. Cl. E05D 3/02; E05D 11/10

(52) U.S. Cl. CPC E05D 3/02; E05D 11/10
USPC 16/325

(57) ABSTRACT

A hinge module and an electronic device are provided. The electronic device includes a first body and a second body. The hinge module connected between the first body and the second body includes a shaft, a first cam plate, a second cam plate, a knob pivoted to the shaft, and an elastic member. The shaft is connected to the first body and the second body. The first cam plate pivoted to the shaft has a first pressing portion. The second cam plate slidably sheathed onto the shaft has a second pressing portion. The elastic member pressed between the second cam plate and the knob drives the second pressing portion to press against the first pressing portion. The knob rotates relative to the shaft to adjust friction between the first pressing portion and the second pressing portion.

### CROSS-REFERENCE TO RELATED APPLICATION

This application claims the priority benefit of Taiwan application serial no. 102113306, filed on Apr. 15, 2013. The entirety of the above-mentioned patent application is hereby incorporated by reference herein and made a part of this specification.

### FIELD OF THE INVENTION

The present invention relates to a hinge module. More particularly, the present invention relates to a hinge module of an electronic device.

### DESCRIPTION OF RELATED ART

With development of science and technology, portable computing devices, such as palmtops, laptops, notebook computers, tablet PCs, and personal digital assistants (PDA), have become more and more common. In general, a portable electronic device includes a base unit and a display assembly configured for the display of the base unit to comply with user operation and viewing purposes. In particular, as touch display technology advances with years, in terms of the portable computers, touch screens have gradually become the basic equipments.

Taking the notebook computer as an example, a hinge between two bodies is used as a mechanism for causing movements between the bodies. However, once a touch screen is added, at the same time the bodies are in the unfolded state, the hinge still requires being able to support a force applied on the touch screen by a user. Meanwhile, a cable connected between the bodies also has to pass through the hinge structure. Therefore, how to develop a hinge structure with supporting strength and structural strength, and be able to provide a space for the cable to pass through without damaging the cable has become an important issue to designers.

### SUMMARY OF THE INVENTION

The present invention is directed to a hinge module and an electronic device, wherein the hinge module provides the required support for the electronic device in different unfolded states by adjusting the torsion of the hinge module.

A hinge module of the invention is adapted to be disposed at an electronic device. The electronic device includes a first body and a second body. The hinge module is connected between the first body and the second body, such that the first body rotates relatively to the second body by the hinge module. The hinge module includes a shaft, a first cam plate, a second cam plate, a knob and an elastic member. The shaft is connected to the first body and the second body. The first cam plate is sheathed onto the shaft and has a first pressing portion. The second cam plate is slidably sheathed onto the shaft and has a second pressing portion. The knob is sheathed onto the shaft. The elastic member is sheathed onto the shaft and pressed between the second cam plate and the knob. The elastic member drives the second pressing portion to press against the first pressing portion. The knob rotates relatively to the shaft to adjust friction between the first pressing portion and the second pressing portion.

An electronic device of the present invention includes a first body, a second body and a hinge module. The hinge module is connected between the first body and the second body, such that the first body rotates relatively to the second body by the hinge module. The hinge module includes a shaft, a first cam plate, a second cam plate, a knob and an elastic member. The shaft is connected to the first body and the second body. The first cam plate is sheathed onto the shaft and has a first pressing portion. The second cam plate is slidably sheathed onto the shaft and has a second pressing portion. The knob is sheathed onto the shaft. The elastic member is sheathed onto the shaft and pressed between the second cam plate and the knob. The elastic member drives the second pressing portion to press against the first pressing portion. The knob rotates relatively to the shaft to adjust friction between the first pressing portion and the second pressing portion.

Based on the embodiments described above, with the cam plates and the elastic member of the hinge module cooperated with each other, when the knob is rotated by a user, the hinge module drives the first cam plate to press against the second cam plate by the elastic member to increase the friction between the first cam plate and the second cam plate, such that the torsion of the hinge module is increased, wherein the torsion is used to be the required support for the electronic device when the bodies are unfolded or a touch action is performed on the bodies.

To make the above features and advantages of the invention more comprehensible, several embodiments accompanied with drawings are described in detail as follows.

### BRIEF DESCRIPTION OF THE DRAWINGS

FIG. 1 and FIG. 2 are schematic views respectively illustrating an electronic device in two different states according to an embodiment of the present invention.

FIG. 3 is a schematic view illustrating a hinge structure of the electronic device in FIG. 1 and FIG. 2.

FIG. 4 is a cross-sectional view of the hinge module in FIG. 3.

FIG. 5 and FIG. 6 are schematic views respectively illustrating different portions of components of the hinge structure in FIG. 3.

### DESCRIPTION OF EMBODIMENTS

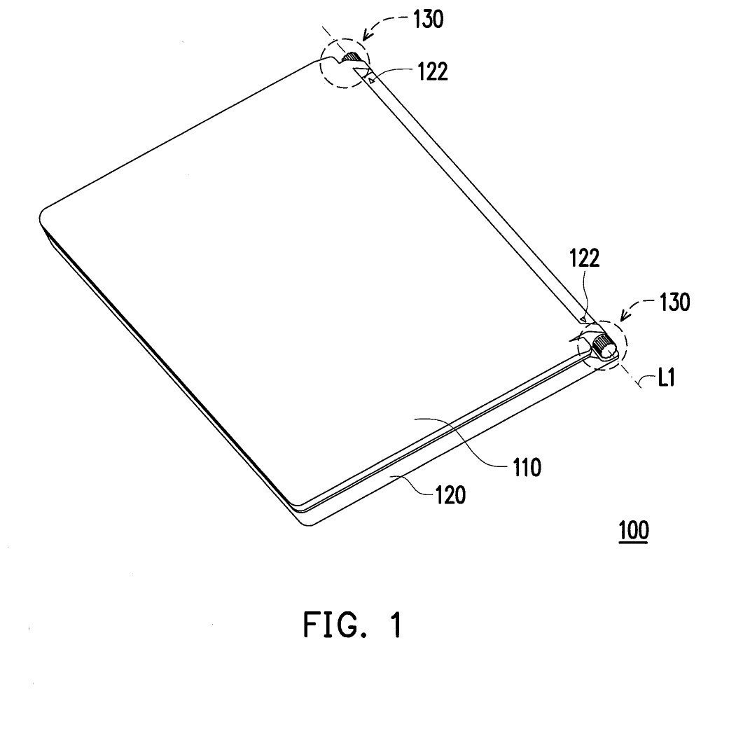

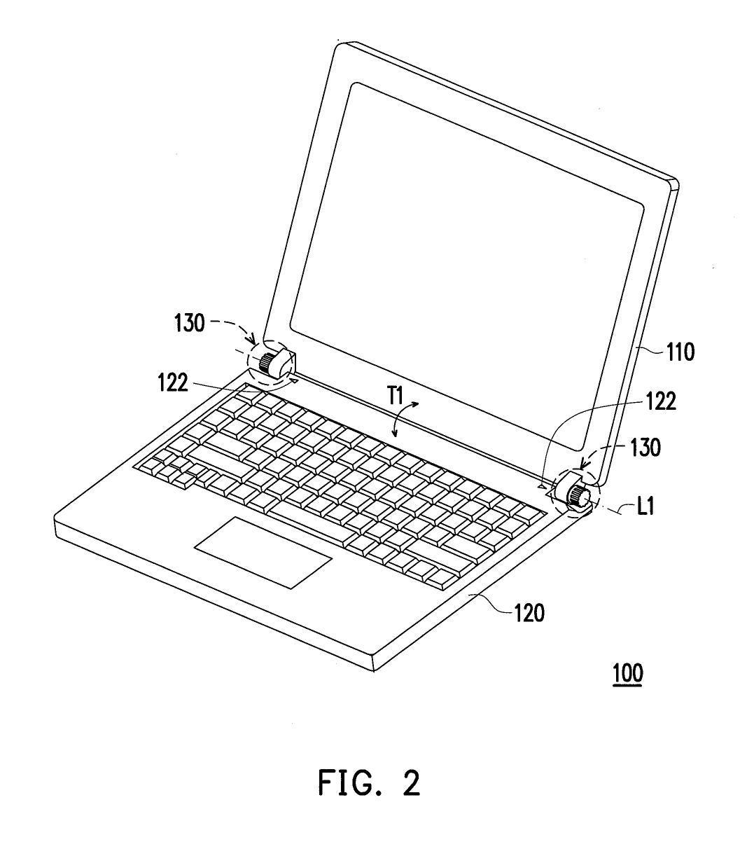

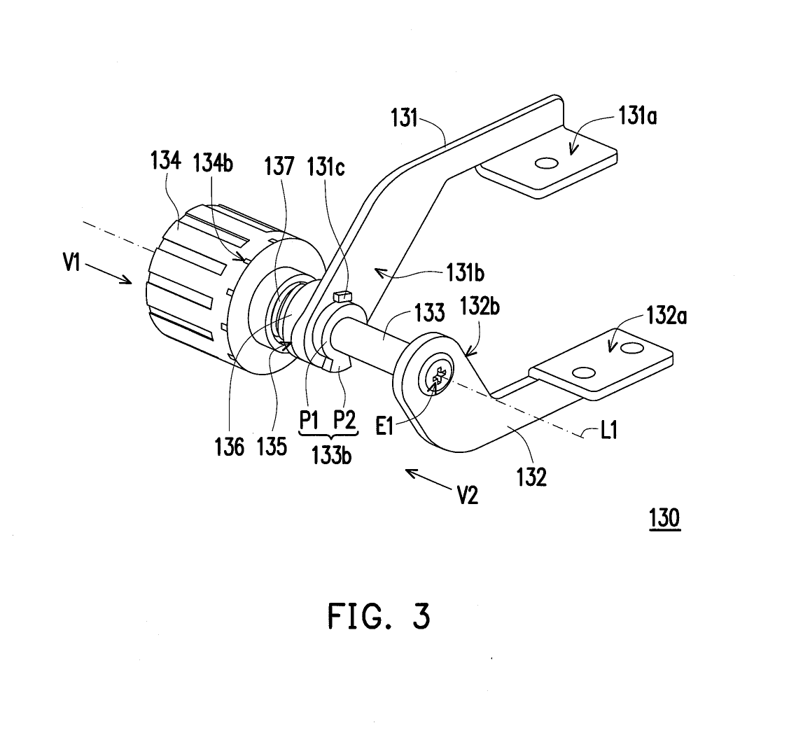

FIG. 1 and FIG. 2 are schematic views respectively illustrating an electronic device in two different states according to an embodiment of the present invention. FIG. 3 is a schematic view illustrating a hinge structure of the electronic device in FIG. 1 and FIG. 2. Referring to FIG. 1 to FIG. 3, in the present embodiment, an electronic device 100 is, for example, a notebook computer, and includes a first body 110, a second body 120 and a pair of hinge modules 130 connected therebetween. The first body 110 and the second body 120 rotate relatively to each other by the hinge module 130 so as to be in the close state as shown in FIG. 1 or the unfolded state as shown in FIG. 2. Herein, the second body 120 is, for example, a host of the notebook computer, and the first body 110 is, for example, a display of the notebook computer. In particular, the first body 110 may be a touch-control display, so that a user can perform operate the electronic device 100 not only by the input device, for example, the keyboard and the touch pad shown in FIG. 2,of the host, but also by the touch-control display.

It should be noted that the hinge modules 130 of the present embodiment are arranged symmetrically corresponding to the first body 110 and the second body 120, but the present invention is not limited thereto. In other non-illustrated embodiment, the electronic device 100 may adopt one hinge module as the rotating mechanism between the bodies according to the design requirements of the electronic device. One of the hinge modules 130 of the present embodiment are described in detail as follows for reference.

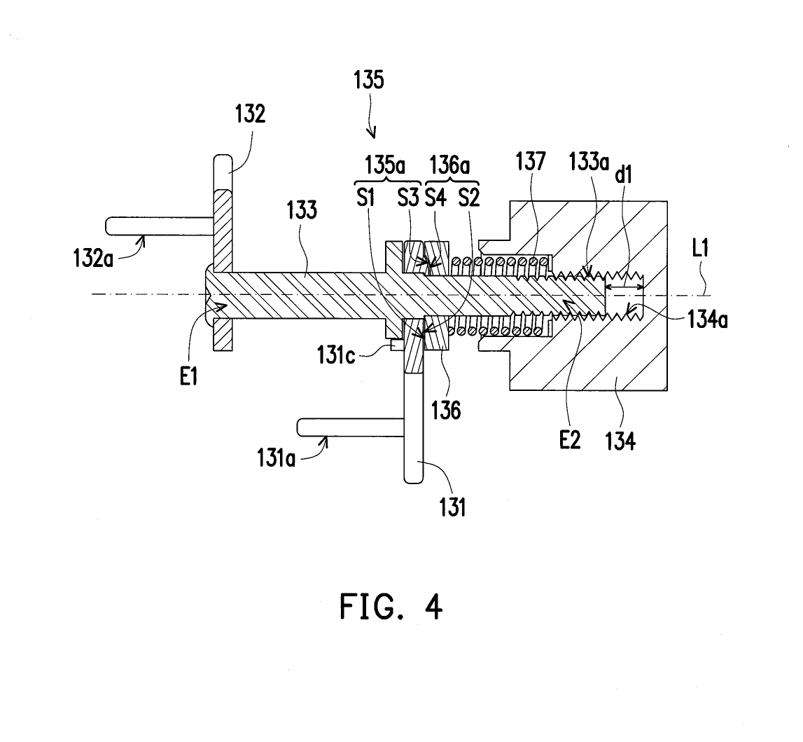

Referring to FIG. 3, the hinge module 130 includes a shaft 133, a first bracket 131, a second bracket 132 and a knob 134. A first side 132a of the second bracket 132 is fixed to the second body 120, and a second side 132b of the second bracket 132 is connected to the a first end E1 of the shaft 133 by locking, riveting or welding. The first side 131a of the first bracket 131 is fixed to the first body 110, and the second side 131b of the first bracket 131 is pivoted to the shaft 133, such that the first body 110 is able to rotate about an axis L1 of the shaft 133 by the first bracket 131. The knob 134 is sheathed onto a second end E2 (shown in FIG. 4) of the shaft 133.

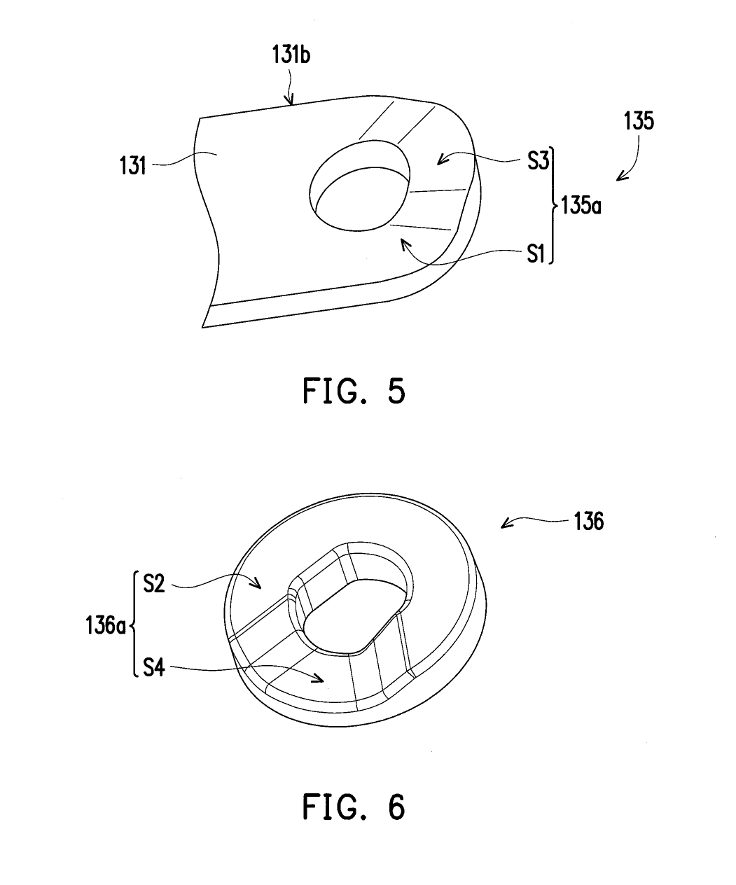

FIG. 4 is a cross-sectional view of the hinge module in FIG. 3. FIG. 5 and FIG. 6 are schematic views respectively illustrating different portions of components of the hinge structure in FIG. 3. Referring to FIG. 3 to FIG. 6, the hinge module 130 of the present embodiment further includes a first cam plate 135, a second cam plate 136 and an elastic member 137, wherein the second cam plate 136 may slidably sheathed onto the shaft 133, and the elastic member 137 is sheathed onto the shaft 133 and pressed between the knob 134 and the second cam plate 136. Herein, FIG. 5 is a schematic view illustrating the first bracket 131 in FIG. 3 in a view angle V1, and FIG. 6 is a schematic view illustrating the second cam plate 136 in FIG. 3 in a view angle V2.

It should be noted that the first cam plate 135 is pivoted to the shaft 133. To be more specific, the first cam plate 135 is formed at the second side 131b of the first bracket 131 and is integrally formed with the first bracket 131. Moreover, the first cam plate 135 has a first pressing portion 135a, and the second cam plate 136 has a second pressing portion 136a facing the first pressing portion 135a. Therefore, by tightly disposed the components described above together, the elastic member 137 is pressed between the knob 134 and the second cam plate 136, so as to utilize the elastic force thereof to drive the second pressing portion 136a pressing against the first pressing portion 135a.

In detail, in the present embodiment, the first pressing portion 135a has a convex surface S3 and a first flat surface S1, and the second pressing portion 136a has a concave surface S4 and a second flat surface S2. When the electronic device 100 is in the close state shown in FIG. 1, the hinge module 130 is in the state shown in FIG. 3 and FIG. 4. At the time, the convex surface S3 presses against the concave surface S4, and the first flat surface S1 presses against the second flat surface S2, so as to present the state that the first cam plate 135 and the second cam plate 136 engaged with each other. When the electronic device 100 is switched from the close state shown in FIG. 1 to the unfolded state shown in FIG. 2, the convex surface S3 is moved from the concave surface S4 to the second flat surface S2, so that the first cam plate 135 and the second cam plate 136 are gradually moved away from each other. That is to say, the components are moved away from each other when rotating relatively to each other due to the contours of the components. Accordingly, the elastic member 137 is compressed, while another end of the elastic member 137 still presses against the knob 134, such that an elastic counterforce of the elastic member 137 still drives the second cam plate 136 to press against the first cam plate 135. In other words, the convex surface S3, at the time, is rotated to press against the second flat surface S2. Therefore, under the condition of the components of the hinge module 130 still tightly disposed, friction between the first cam plate 135 and the second cam plate 136 is increased by the elastic member 137, so as to increase the torsion of the hinge module 130 and be able to provide enough supporting force for the electronic device 100 when the first body 110 and the second body 120 thereof are unfolded relatively to each other.

In addition, referring to FIG. 4, the knob 134 of the present embodiment has an inner threaded hole 134a, and the shaft 133 has an outer thread 133a located at the second end E2. Therefore, a distance d1 between the knob 134 and the shaft 133 may be adjusted by the cooperation of the inner threaded hole 134a of the knob 134 and the outer thread 133a of the shaft 133. When the distance d1 is reduced due to the rotation of the knob 133, the knob 133 drives the second cam plate 136 to move toward the first cam plate 135 by the elastic member 137, so as to increase the friction between the first pressing portion 135a and the second pressing portion 136a. In other words, by doing so, the user may enhance the torsion of the hinge module 130. For example, when the electronic device 100 is in the unfolded state shown in FIG. 2, the friction between the first cam plate 135 and the second cam plate 136 deemed as the supporting force for the first body 110 is increased by moving the convex surface S3 of the first cam plate 136 to press against the second flat surface S2 and be cooperated with the elastic member 137. Moreover, the friction between the first cam plate 135 and the second cam plate 136 may be further increased by adjusting the knob 134 to reduce the distance d1, so as to improve the jointing strength between the first bracket 131 and the second bracket 132, and provide enough supporting force for the first body 110, such that the wobble of the first body 110 would not occur when the user operates the electronic device 100 by the touch screen.

In addition, referring to FIG. 2 and FIG. 3, in the present embodiment, the first bracket 131 further has a first stopper 131c, for example, a bump, at the second side 131b. The first stopper 131c rotates about the axis L1 of the shaft 133 along with the first bracket 131, and the shaft 133 has a second stopper 133b extended along a radial direction of the shaft 133. To be specific, the second stopper 133b includes a first portion P1 and a second portion P2, wherein the first portion P1 is connected between the body of the shaft 133 and the second portion P2, and the second portion P2 is located on the rotating path of the first stopper 131c. As shown in FIG. 2, the first portion P1 is the stopper to keep the second bracket 132 from moving along the axis L1 (toward the right side of the figure). Moreover, the first stopper 131c rotates to the second portion P2 of the second stopper 133b and interferes with the second portion P2 when the first body 110 is unfolded to an angle T1 relatively to the second body 120, so as to stop the first bracket 131 (first body 110) from moving toward the position where the angle between the first body 110 and the second body 120 is greater than the angle T1, such that the position where the first body 110 is unfolded to the angle T1 relatively to the second body 120 is the ultimate position. In other words, the second stopper 133b can achieve the effects of stopping the first bracket 131 from moving along the axial direction and the radial direction of the shaft simultaneously.

On the other hand, the knob 134 further has a plurality of first identification signs 134b located on the outer surface of the knob 134. A plurality of pits are illustrated as the first identification signs 134b herein but the present invention is not limited thereto. In other non-illustrated embodiment, the first identification signs 134b may be quantified by numeral scale. The second body 120 has a second identification sign 122 (shown in FIGS. 1, 2) located on the top surface of the second body 122 and is right next to the hinge module 130. Similarly, the triangular patterns are illustrated as the second identification sign 122 herein but the present invention is not limited thereto. In the present embodiment, when the knob 134 rotates relatively to the shaft 133, one of the first identification signs 134b (shown in FIG. 3) is aligned with the second identification sign 122, such that the user can easily identify the current magnitude of the torsion of the hinge module 130 to adjust the torsion according to using condition of the electronic device 100.

In sum, in the embodiments described above of the present invention, with the cam plates corresponding to each other cooperated with the elastic member located at one side of the cam plates, the relative position of the above-mentioned components along the rotating axis can be adjusted by a user rotating the knob, such that elastic force of the elastic member drives the cam plates to press against to each other, and the friction between the first cam plate and the second cam plate is increased when the elastic force is increased, so as to increase the torsion of the hinge module, wherein the torsion is used as the supporting force required for supporting the electronic device when the bodies thereof are unfolded or the user operates the electronic device by the touch screen. Thereby, the user may adjust the torsion of the hinge module according to the operating condition of the electronic device, such that the electronic device can be operated easily and conveniently.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A hinge module, adapted to be disposed at an electronic device, the electronic device including a first body and a second body, and the hinge module connected between the first body and the second body, such that the first body and the second body rotate relatively to each other by the hinge module, the hinge module comprising:
a shaft, connected to the first body and the second body;
a first cam plate, pivoted to the shaft and having a first pressing portion;
a second cam plate, slidably sheathed onto the shaft and having a second pressing portion;
a knob, sheathed onto the shaft; and
an elastic member, sheathed onto the shaft and pressed between the second cam plate and the knob, the elastic member driving the second pressing portion to press against the first pressing portion, the knob rotating relatively to the shaft to adjust friction between the first pressing portion and the second pressing portion.

2. The hinge module as claimed in claim 1, wherein the first pressing portion has a convex surface, and the second pressing portion has a concave surface, and the convex surface presses against the concave surface when the first body is close relatively to the second body.

3. The hinge module as claimed in claim 2, wherein the first pressing portion further has a first flat surface, the second pressing portion further has a second flat surface, and the convex surface is moved from the concave surface to the second flat surface when the first body is unfolded relatively to the second body.

4. The hinge module as claimed in claim 1, further comprising:
a first bracket, having a side assembled to the first body and another side pivoted to the shaft, and the first bracket further having the first cam plate; and
a second bracket, having a side assembled to the second body and another side connected to a first end of the shaft.

5. The hinge module as claimed in claim 4, wherein the first bracket further has a first stopper rotating relatively to the shaft along with the first bracket, the shaft has a second stopper extended along a radial direction of the shaft and located on a rotating path of the first stopper, and the first stopper and the second stopper interferes with each other to stop the first body from keeping unfolded relatively to the second body when the first body is unfolded to an angle relatively to the second body.

6. The hinge module as claimed in claim 1, wherein the knob and a second end of the shaft are screwed to each other to adjust a distance between the knob and the shaft, and the knob drives the second cam plate to move toward the first cam plate by the elastic member when the distance is reduced, such that the friction between the first pressing portion and the second pressing portion is increased.

7. An electronic device, comprising:
a first body;
a second body; and
a hinge module, connected between the first body and the second body, such that the first body rotates relatively to the second body by the hinge module, the hinge module comprising:
a shaft, connected to the first body and the second body;
a first cam plate, pivoted to the shaft and having a first pressing portion;
a second cam plate, slidably sheathed onto the shaft and having a second pressing portion;
a knob, sheathed onto the shaft; and
an elastic member, sheathed onto the shaft and pressed between the second cam plate and the knob, the elastic member driving the second pressing portion to press against the first pressing portion, the knob rotating relatively to the shaft to adjust friction between the first pressing portion and the second pressing portion.

8. The electronic device as claimed in claim 7, wherein the first pressing portion has a convex surface, and the second pressing portion has a concave surface, and the convex surface is pressed against the concave surface when the first body is close relatively to the second body.

9. The electronic device as claimed in claim 8, wherein the first pressing portion further has a first flat surface, the second pressing portion further has a second flat surface, the first flat surface is pressed against the second flat surface when the first body is close relatively to the second body, and the convex surface is moved from the concave surface to the second flat surface when the first body is unfolded relatively to the second body.

10. The electronic device as claimed in claim 7, further comprising:
a first bracket, having a side assembled to the first body and another side pivoted to the shaft, and the first bracket further having the first cam plate; and
a second bracket, having a side assembled to the second body and another side connected to a first end of the shaft.

11. The electronic device as claimed in claim 10, wherein the first bracket further has a first stopper rotating relatively to the shaft along with the first bracket, the shaft has a second stopper extended along a radial direction of the shaft and located on a rotating path of the first stopper, the first stopper and the second stopper interferes with each other to stop the first body from keeping unfolded relatively to the second body when the first body is unfolded relatively to the second body to an angle.

12. The electronic device as claimed in claim 7, wherein the knob and a second end of the shaft are screwed to each other to adjust a distance between the knob and the shaft, and the knob drives the second cam plate to move toward the first cam plate by the elastic member when the distance is reduced, such that the friction between the first pressing portion and the second pressing portion is increased.

13. The electronic device as claimed in claim 7, wherein the knob has a plurality of first identification signs, the second body has a second identification sign, and the knob rotates relatively to the shaft, such that one of the first identification signs is aligned with the second identification sign.
